(19) United States
(12) Patent Application Publication
(10) Pub. No.: US 2008/0289909 A1
(43) Pub. Date: Nov. 27, 2008

(54) Elevator Shock Absorber

(76) Inventors: Mitsuru Kato, Chiba (JP); Yasuhiko Masui, Kanagawa (JP); Toshiyuki Fujii, Chiba-shi (JP)

Correspondence Address: CARLSON GASKEY & OLDS, 400 W MAPLE STE 350, BIRMINGHAM, MI, 48009, US

(21) Appl. No.: 12/095,323

(22) PCT Filed: Nov. 13, 2006
(86) PCT No.: PCT/US06/43970

§ 371 Date: May 29, 2008

(30) Foreign Application Priority Data
Dec. 9, 2005 (JP) 2005-355522

(51) Int. Cl. B66B 5/28

(52) U.S. Cl. 187/343

(57) ABSTRACT

A car shock absorber is positioned on a pit floor car between a car guide rail and the pit floor and/or between the car or counterweight and the pit floor. The car shock absorber has a shock absorbing body made of a deformable material in which a recess is formed. A pressing body is continuously engaged in the recess. When a shock load is input to a top part of the pressing body, the load is distributed in a direction perpendicular to inclined pressure and pressure-receiving surfaces, which are the contact surfaces between the pressing body and the shock absorbing body, thereby reducing the shock stress produced in the pit floor.

### CROSS-REFERENCE TO RELATED APPLICATIONS

### Background

The present invention relates to a shock absorber placed on the pit floor of an elevator. In particular, it relates to a shock absorber that: (a) contacts the car or counterweight to moderate shock when the elevator car travels past the normal stop position at the bottom floor or top floor; and (b) moderates the shock applied to the pit floor via a guide rail that guides travel of the car or counterweight when an emergency stop apparatus provided for the car or counterweight is activated.

A shock absorber is provided in the pit at the bottom of the hoistway for the purpose of stopping the car or counterweight safely, should an elevator malfunction occur causing the car to travel past the normal stop position at the bottom floor or top floor. For example, with regard to the form of the shock absorber, a spring-type shock absorber is described in Japanese Kokai Patent Application No. JP2000-136075 and an oil-filled shock absorber is described in Japanese Kokai Patent Application No. JP7-237846. Each of these conventional shock absorbers, which are placed facing the car or counterweight on the pit floor, contacts the car or counterweight when the car travels past the normal stop position at the bottom floor or top floor. A downward stroke of the shock absorber moderates shock applied to the car or counterweight.

With regard to the car and the counterweight, an emergency stop apparatus is provided at least for the car in which passengers ride to control the car's descent, when the rate of descent increases markedly for any reason. In addition, when the bottom part of the pit is used as a space in which people stand, an emergency stop apparatus may also be provided for the counterweight. The emergency stop apparatus secures the car or counterweight to the guide rail that guides travel of the car or counterweight and forcibly stops the car or counterweight. That is, the aforementioned guide rail, which is installed to run vertically upward from the pit floor, functions as a support that supports the car or counterweight when the emergency stop apparatus is activated.

With the aforementioned conventional shock absorbers, when the car or counterweight impacts the shock absorber a very large shock load acts locally on, and largely stresses, the part directly below the shock absorber in the pit floor. Even when the emergency stop apparatus provided for the car or counterweight is activated, a shock load transmitted by the guide rail acts locally on, and largely stresses, the part of the pit floor directly below the guide rail (due to the car or counterweight being secured to the guide rail and stopping suddenly). Therefore, the pit floor must withstand the shock stress when the car or counterweight strikes the shock absorber and when the emergency stop apparatus is activated. As a result, an increased cost to ensure the shock absorber's strength is incurred.

In the event that the car or counterweight strikes the top end of the shock absorber, the car is decelerated and stopped while the shock absorber is stroking downward. However, with a conventional shock absorber, in addition to the stroke length, the total height of the shock absorber must be increased by the spring length after compression for a spring-type shock absorber or by the total height of the cylinder for an oil-filled shock absorber. As a result, the pit depth must be made correspondingly deeper.

In light of the foregoing, the present invention aims to resolve one or more of the aforementioned issues that afflict conventional elevator shock absorbers.

### SUMMARY

An embodiment of the invention addresses an elevator shock absorber that includes, among other possible things: (a) a shock absorbing body, which is configured to be positioned on the pit floor, that is formed of an deformable material, the shock absorbing body including a recess that has an inclined surface; and (b) a pressing body that has an inclined surface that is configured to engage the inclined surface of the recess of the shock absorbing body. The shock absorber is configured to: (a) be arranged on a pit floor opposite a car or counterweight; (b) contact the car or counterweight; and (c) moderate a shock when the car travels past a normal stop position at a bottom floor or top floor. The shock absorbing body is configured to deform so that the recess is widened by contact between the inclined surface of the shock absorbing body and the inclined surface of the pressing body, to absorb the shock when a shock load is input to the shock absorbing body by the car or counterweight via the pressing body.

Another embodiment of the present invention addresses an elevator shock absorber that includes, among other possible things: (a) a shock absorbing body, which is configured to be positioned on a pit floor, that is formed of an deformable material, the shock absorbing body including a recess that has an inclined surface; and (b) a pressing body that has an inclined surface that is configured to engage the inclined surface of the recess of the shock absorbing body. The shock absorber is configured to: (a) be positioned between a guide rail that is configured to guide a car or counterweight and the pit floor; and (b) moderate a shock applied to the pit floor by the car or counterweight via the guide rail. The shock absorbing body is configured to deform so that the recess is widened by contact between the inclined surface of the shock absorbing body and the inclined surface of the pressing body, to absorb the shock when a shock load is input to the shock absorbing body by the car or counterweight via the pressing body.

In a further embodiment of either of the aforementioned embodiments, the pressing body may be continuously engaged with the shock absorbing body.

In another further embodiment of any of the aforementioned embodiments, the recess may be a tapered hole. Further, the pressing body may have a conical trapezoidal shape that may be configured to engage the tapered hole of the recess.

In another further embodiment of any of the aforementioned embodiments, the pressing body may have a conical trapezoidal shape.

In another further embodiment of any of the aforementioned embodiments, the shock absorbing body may have an outer surface that is reinforced with a frame. Moreover, when the outer surface of the shock absorbing body is reinforced with a frame, the shock absorbing action of the shock absorbing body may function more effectively.

In another further embodiment of any of the aforementioned embodiments, the shock absorbing body may be formed of an elastically deformable material.

In another further embodiment of any of the aforementioned embodiments, the inclined surface of the shock absorbing body may have a substantially V-shaped cross-section. Alternatively or additionally, the inclined surface of the pressing body may have a substantially V-shaped cross-section.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are hereafter briefly described.

FIG. 1 is a cross-sectional view that illustrates a first embodiment of a car shock absorber in an elevator pit;

FIGS. 2A and 2B show the details of the shock absorber embodiment shown in FIG. 1 in which FIG. 2A is a plan view and FIG. 2B is a cross-section taken along line A-A in FIG. 2A;

FIG. 3 schematically shows a load distribution for the shock absorber shown in FIGS. 2A and 2B using a two-dimensional model;

FIG. 4 schematically shows a load distribution for a conventional shock absorber using a two-dimensional model;

FIG. 5 is a partially cut-away plan view that shows the details of a car guide rail and a guide rail shock absorber;

FIG. 6 is a plan view of the guide rail shock absorber shown in FIG. 5; and

FIGS. 7A and 7B show a second embodiment of a shock absorber in which FIG. 7A is a plan view of a shock absorber and FIG. 7B is a cross-section taken along line B-B in FIG. 7A.

### DETAILED DESCRIPTION

Efforts have been made throughout the drawings to use the same or similar reference numerals for the same or like components.

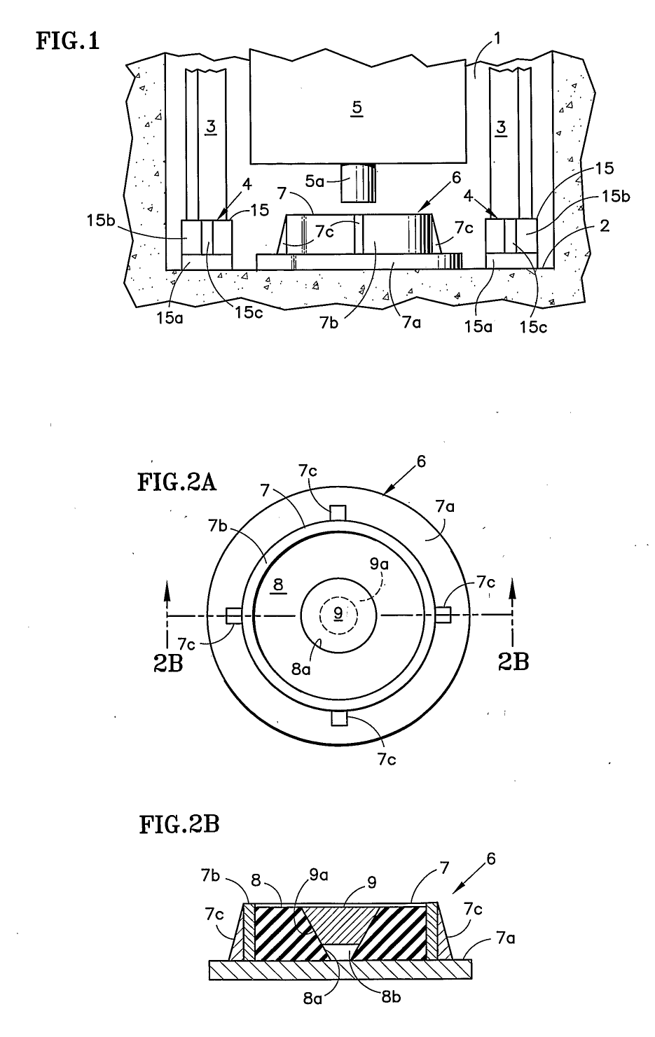

FIG. 1 shows an embodiment of a shock absorber that is positioned in an elevator pit. As shown in FIG. 1, two guide rails 3, with T-shaped cross-sections, are vertically installed to run from respective guide rail shock absorbers 4 on the pit floor 2. The shock absorbers 4 are positioned at the bottom end of a hoistway 1. A car shock absorber 6 is also arranged at a position on pit floor 2 to face a car 5 that travels along the two car guide rails 3. The car 5 may also have an emergency stop apparatus, not shown. A shock absorber contact part 5a, which is configured to contact the car shock absorber 6 should the car 5 travel beyond a normal stop position at the bottom floor, is provided on a lower surface of the car 5.

FIGS. 2A and 2B show the details of the car shock absorber 6. FIG. 2A is a plan view and FIG. 2B is a cross-section at A-A in FIG. 2A. As shown in FIGS. 2A and 2B, the car shock absorber 6 includes a rigid cylindrical frame 7b that is fixed to a top surface of a disk-shaped base plate 7a that is configured to be provided on the pit floor 2. The outer wall surface of the frame 7b and the top surface of the base plate 7a are connected by four reinforcing pieces 7c that are provided at substantially equal spacing around the outer wall surface of the frame 7b. A car-side shock absorbing body mount 7 includes the base plate 7a, the frame 7b, and the reinforcing pieces 7c.

A shock absorbing body 8 that is formed of an elastic rubber material, for example, urethane rubber, is placed inside the car-side shock absorbing body mount 7. A tapered recess in the form of a hole 8b, which has an inclined pressure-receiving surface 8a that has a V-shaped cross-section, is formed in the center of the shock absorbing body 8. A pressing body 9 is continuously engaged in the tapered recess 8b. The pressing body 9, which is formed of a highly rigid material, for example, steel, has a conical, trapezoidal shape. A pressing surface 9a of the pressing body 9 has an inverted V-shaped cross-section; the inclined surface 9a has the same slope as the pressure-receiving surface 8a. The car shock absorber 6 includes the car-side shock absorbing body mount 7, the shock absorbing body 8, and the pressing body 9.

With the car shock absorber 6, if the car 5 descends significantly beyond the normal stopping point at the bottom floor for any reason, the shock absorber contact part 5a of the car 5 contacts the top surface of the pressing body 9 of the car shock absorber 6. In turn, the pressing body 9 is pressed downward and the shock load is input to the shock absorbing body 8. When the shock load is input to the shock absorber body 8, the inclined surface contact between the pressing surface 9a and the pressure-receiving surface 8a causes the shock absorbing body 8 to deform elastically so that the tapered recess 8b widens and the pressing body 9 is displaced downward so that the shock is absorbed. In conjunction with this, the descent rate of the car 5 is gradually reduced, and the car 5 ultimately stops. The outer surface of the shock absorbing body 8 opposite the pressure-receiving surface 8a that is pressed by the pressing body 9 is reinforced by the frame 7b. The vertical downward shock load acting on the top surface of the pressing body 9 is transmitted to the shock absorbing body 8 from the pressing body 9 and is distributed in a direction perpendicular to the inclined surfaces of the pressure-receiving surface 8a and the pressing surface 9a, thereby reducing the shock stress produced in the pit floor 2.

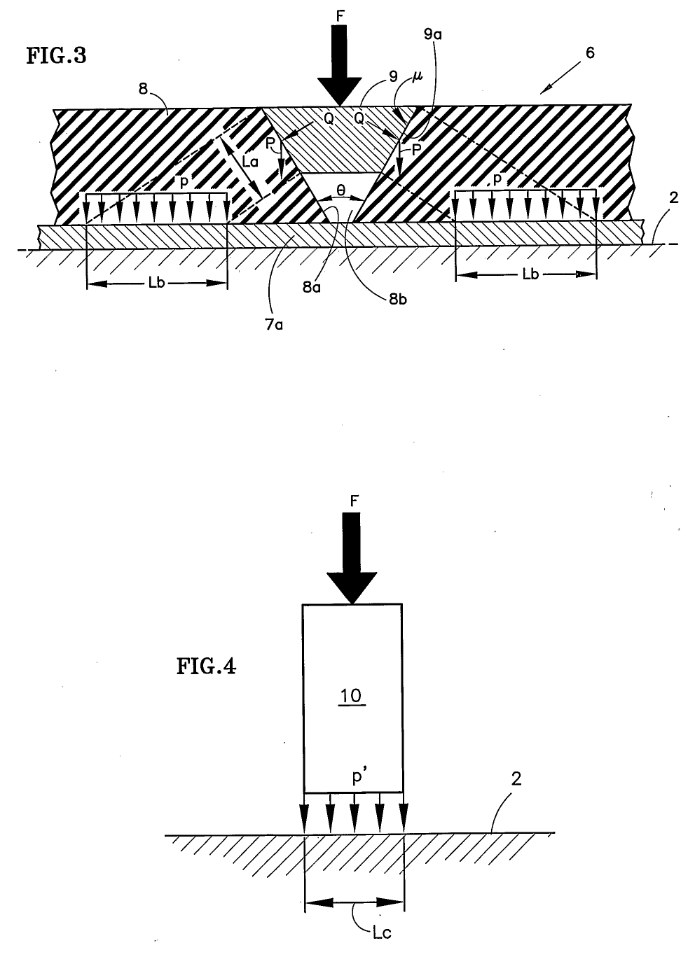

FIG. 3 shows the load distribution when the car 5 presses the top surface of the pressing body 9, in a two-dimensional model. FIG. 4 shows the load distribution when the car presses a conventional shock absorber, in a two-dimensional model. More specifically, when the shock absorber contact part 5a of the car 5 contacts the top surface of the pressing body 9, a load F is applied to the top surface of the pressing body 9, as shown in FIG. 3. As a result of the application of load F, a load Q acts in a direction perpendicular to the inclined surfaces of the pressure-receiving surface 8a and the pressing surface 9a, which are the contact surfaces between the shock absorbing body 8 and the pressing body 9, as represented by Equation 1 below. Here, μ is the coefficient of friction between the pressing body 9 and the shock absorbing body 8 and θ is the apex angle of the tapered recess 8b and the pressing body 9. A load P that is the component force of the load Q that acts vertically downward is represented by Equation 2 below. Letting the contact length between the pressing body 9 and the shock absorbing body 8 be La, length Lb over which load is applied on the bottom surface of the shock absorbing body 8 is represented by Equation 3 below. A load p per unit length applied to the pit floor 2 is represented by Equation 4. Therefore, the load p is represented by Equation 5 below when Equations (1)-(4) below are rearranged.

$$\begin{matrix}Q = \frac{F}{2 ( sin \frac{θ}{2} + μ cos \frac{θ}{2} )} & ( 1 ) \\ P = Q sin \frac{θ}{2} & ( 2 ) \\ Lb = \frac{La}{sin \frac{θ}{2}} & ( 3 ) \\ P = \frac{P}{Lb} & ( 4 ) \\ p = \frac{F sin \frac{θ}{2}}{2 Lb ( sin \frac{θ}{2} + μ cos \frac{θ}{2} )} & ( 5 )\end{matrix}$$

For example, assuming that the load F is 15 kN, the contact length La is 50 mm, the coefficient of friction μ is 0.2, and the apex angle θ is 45°, the load p per unit length applied to the pit floor 2 will be about 38.6 N/mm. On the other hand, as shown in FIG. 4, when a 15 kN load F acts on a conventional shock absorber 10, with the contact length Lc with pit floor 2 being 150 mm, for example, a load p′ per unit length applied to pit floor 2 will be 100 N/mm. Therefore, with the aforementioned conditions, the load per unit length applied to the pit floor 2 will be reduced to about 38.6% of that for a conventional shock absorber 10, when the car shock absorber 6 is used.

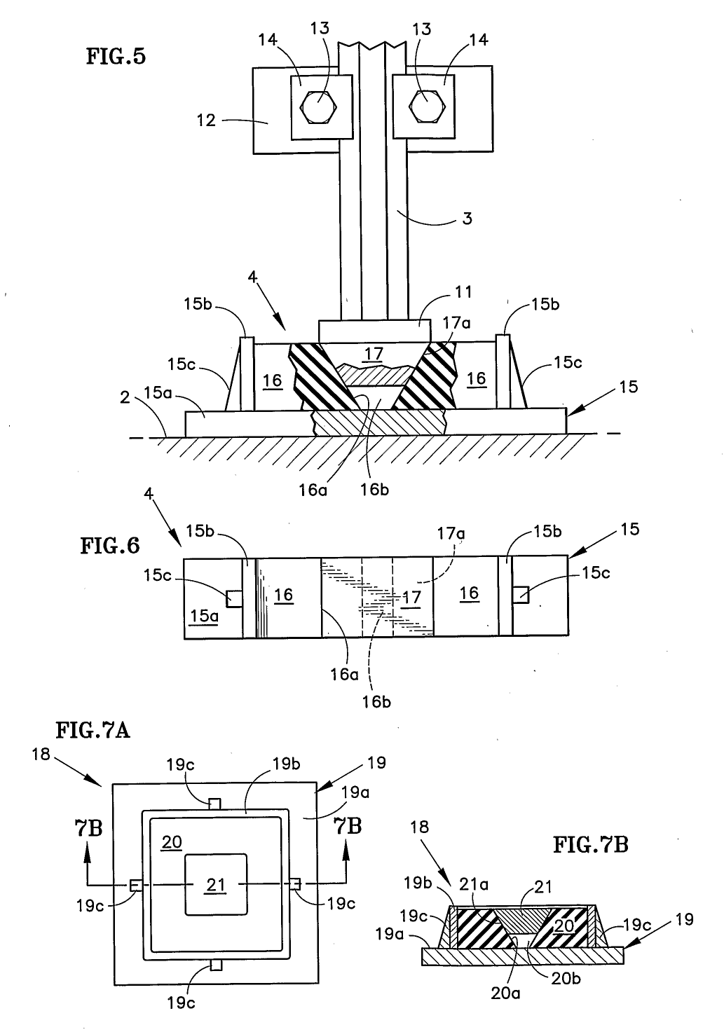

FIG. 5 is a partially cut-away front view showing the details of the guide rail 3 and the guide rail shock absorber 4. FIG. 6 is a plan view of the guide rail shock absorber 4. As shown in FIG. 5, the car guide rail 3 is installed vertically above the guide rail shock absorber 4 via an intervening end plate 11. The guide rail 3 is held between a rail bracket 12 (that is connected to the outer wall of hoistway 1, not shown in FIG. 5) and a pair of rail clips 14 (that are mounted to rail bracket 12 by bolts 13). Note that a plurality of rail brackets 12 and rail clips 14 are provided at substantially equal spacing along the length of the car guide rail 3, such that leaning of the car guide rail 3 is controlled by the plurality of rail brackets 12 and rail clips 14.

As shown in FIGS. 5 and 6, the guide rail shock absorber 4 provided on the pit floor 2 comprises a pair of rectangular and rigid frames 15b. The rigid frames 15b are arranged facing in the lengthwise direction along a top surface of a rectangular base plate 15a. An outer wall surface of the frames 15b and the top surface of the base plate 15a are connected by reinforcing pieces 15c. The reinforcing pieces 15c are provided on the outer wall surfaces of the two frames 15b. A rail-side shock absorbing body mount 15 includes the base plate 15a, the frames 15b, and the reinforcing pieces 15c.

Two shock absorbing bodies 16 are arranged between the two frames 15b, apart from each other and facing in the lengthwise direction of the base plate 15a. A recess 16b, which has an inclined pressure-receiving surface 16a with an inverted V-shaped cross-section, is formed between the two shock absorbing bodies 16. The two shock absorbing bodies 16 are made of an elastic rubber material, for example, urethane rubber. A pressing body 17 is continuously engaged in the recess 16b. The pressing body 17, which is formed from a highly rigid material, for example, steel, is wedge-shaped with a pressuring surface 17a that has an inverted V-shaped cross-section with an inclined surface with the same slope as the pressure-receiving surface 16a. The guide rail shock absorber 4 includes the pressing body 17, the shock absorbing body 16, and the rail-side shock absorbing body mount 15.

With the guide rail shock absorber 4, if the descent rate of the car 5 increases markedly and the emergency stop apparatus, which is not shown, is activated, a downward shock load acts on the car guide rail 3. As a result, the pressing body 17 is pressed downward because the car 5 is secured to the guide rail 3 and stops suddenly. When the pressing body 17 is pressed downward, a shock load is input to both of the shock absorbing bodies 16. Further, due to contact between the inclined nature of the pressing surfaces 17a and the pressure-receiving surfaces 16a, as with the car shock absorber 6, the shock absorbing body 16 is elastically deformed so that recess 16b widens and the pressing body 17 is displaced downward, such that the shock is absorbed. Note that the outer surfaces of the two shock absorbing bodies 16 on the side opposite the pressure-receiving surfaces 16a that are pressed by pressing body 17 are reinforced by frames 15b. Accordingly, the shock load applied to the pit floor 2 is distributed and the shock stress produced in the pit floor 2 is reduced in the same way as with the car shock absorber 6.

With an elevator shock absorber as previously described, when a shock load acts on a car shock absorber 6 and a guide rail shock absorber 4, the shock load is distributed over a broad area of the pit floor 2, thereby reducing the shock force produced in the pit floor 2. Therefore, the strength of the pit floor 2 does not have to be as high as that in conventional pit floors, thereby providing a cost benefit by allowing the pit floor slab to be thinner, for example. Further, another advantage of such a shock absorber is that it may be possible to install an elevator using an intermediate floor of a building as the pit.

The shock absorbing body 8 also elastically compresses and deforms in a direction perpendicular to the inclined pressure-receiving surface 8a to absorb the shock when the car 5 strikes the shock absorber 6. As a result, the thickness of shock absorbing body 8 need only be ensured in a direction perpendicular to the inclined pressure-receiving surface 8a on the cross-section. Accordingly, the total height of shock absorber 6 can be reduced by making the shock absorbing body 8 thinner in the vertical direction, thereby reducing the pit depth and yielding space-saving in the hoistway.

FIGS. 7A and 2B depict a second embodiment of a car shock absorber 6 or a guide rail shock absorber 4. FIG. 7A is a plan view and FIG. 7B is a cross-section at B-B in FIG. 7A. As shown in FIGS. 7A and 7B, the second embodiment has a shock absorber 18 that is composed of a shock absorbing body mount 19, a shock absorbing body 20, and a pressing body 21. The pressing body 21 has an inverted square pyramid shape that has an inclined pressing surface 21a with an inverted V-shaped cross-section. In conjunction with this, the shock absorbing body 20 has the shape of a square column. In the center of the shock absorbing body 20 is formed a tapered recess in the form of a hole 20b that has an inverted square pyramid shape. The tapered recess 20 has a pressure-receiving surface 20a as its recess; this is an inclined surface with a V-shaped cross-section that has the same slope as the pressing surface 21a. The pressing body 21 is continuously engaged in the tapered recess 20b. The shock absorbing body mount 19 includes a base plate 19a and a frame 19b that are rectangular in plan view. In addition, the shock absorbing body also includes four reinforcing pieces 19c that connect a top surface of the base plate 19a with an outside wall surface of the frame 19b. This shock absorber 18 can be used in place of the car shock absorber 6 and/or the guide rail shock absorber 4, while attaining the same positive effects of those shock absorbers 4, 6.

In any of the aforementioned embodiments, when the shock absorbing body is pressed by the pressing body, the pressing body may be displaced in a pressing direction so as to widen the recess. At this time, the energy possessed by the pressing body may be absorbed by a deformation (which may be an elastic deformation) of the shock absorbing body so that the recess widens. Also, because the inclined surfaces of the pressing body and the shock absorbing body are in contact, a load pressing the pressing body may be transmitted from the pressing body to the shock absorbing body in a direction perpendicular to the inclined surface of the pressing body on the cross-section and may be distributed over a broad area of the pit floor.

In any of the aforementioned embodiments, shock stresses produced in the pit floor may be reduced because the shock load acting on the pressing body may be distributed over a broad area of the pit floor when the car or counterweight strikes the shock absorber or when an emergency stop apparatus is activated. As a result, a pit floor having a strength as high as previous pit floors may be unnecessary, thereby reducing cost.

In any of the aforementioned embodiments, as the shock absorbing body deforms to widen horizontally, the thickness of the shock absorbing body need only be ensured in a direction perpendicular to the inclined surface in the pressing body on the cross-section. As a result, the total height of the shock absorber may be reduced, thereby correspondingly reducing the depth necessary for the pit.

This application claims priority to, and hereby incorporates by reference in its entirety, Japanese Priority Application No. JP2005-355522, which was filed on Dec. 9, 2005.

The aforementioned discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing

1. An elevator shock absorber comprising:
a shock absorbing body, which is configured to be positioned on a pit floor, that is formed of an deformable material, the shock absorbing body including a recess that has an inclined surface;
a pressing body that has a surface that is inclined at substantially the same angle as the inclined surface of the recess of the shock absorbing body and that is configured to engage the inclined surface of the recess of the shock absorbing body,
wherein the shock absorber is configured to: (a) be arranged on a pit floor opposite a car or counterweight; (b) contact the car or counterweight; and (c) moderate a shock when the car travels past a normal stop position at a bottom floor or top floor, and
wherein the shock absorbing body is configured to deform so that the recess is widened by contact between the inclined surface of the shock absorbing body and the inclined surface of the pressing body, to absorb the shock when a shock load is input to the shock absorbing body by the car or counterweight via the pressing body.

2. The elevator shock absorber described in claim 1, wherein the pressing body is continuously engaged with the shock absorbing body.

3. The elevator shock absorber described in claim 1, wherein the recess is a tapered hole.

4. The elevator shock absorber described in claim 3, wherein the pressing body has a conical trapezoidal shape that is configured to engage the tapered hole of the recess.

5. The elevator shock absorber described in claim 1, wherein the pressing body has a conical trapezoidal shape.

6. The elevator shock absorber described in claim 2, wherein the recess is a tapered hole.

7. The elevator shock absorber described in claim 6, wherein the pressing body has a conical trapezoidal shape that is configured to engage the tapered hole of the recess.

8. The elevator shock absorber described in claim 1, wherein the shock absorbing body has an outer surface that is reinforced with a frame.

9. The elevator shock absorber described in claim 2, wherein the shock absorbing body has an outer surface that is reinforced with a frame.

10. The elevator shock absorber described in claim 3, wherein the shock absorbing body has an outer surface that is reinforced with a frame.

11. The elevator shock absorber described in claim 5, wherein the shock absorbing body has an outer surface that is reinforced with a frame.

12. The elevator shock absorber described in the claim 1, wherein the shock absorbing body is formed of an elastically deformable material.

13. The elevator shock absorber described in claim 1, wherein the inclined surface of the shock absorbing body has a substantially V-shaped cross-section

14. The elevator shock absorber described in claim 1, wherein the inclined surface of the pressing body has a substantially V-shaped cross-section.

15. The elevator shock absorber described in claim 13, wherein the inclined surface of the pressing body has a substantially V-shaped cross-section.

16. An elevator shock absorber comprising:
a shock absorbing body, which is configured to be positioned on a pit floor, that is formed of an deformable material, the shock absorbing body including a recess that has an inclined surface;
a pressing body that has a surface that is inclined at substantially the same angle as the inclined surface of the recess of the shock absorbing body and that is configured to engage the inclined surface of the recess of the shock absorbing body,
wherein the shock absorber is configured to: (a) be positioned between a guide rail that is configured to guide a car or counterweight and the pit floor; and (b) moderate a shock applied to the pit floor by the car or counterweight via the guide rail, and
wherein the shock absorbing body is configured to deform so that the recess is widened by contact between the inclined surface of the shock absorbing body and the inclined surface of the pressing body, to absorb the shock when a shock load is input to the shock absorbing body by the car or counterweight via the pressing body.

17. The elevator shock absorber described in claim 16, wherein the pressing body is continuously engaged with the shock absorbing body.

18. The elevator shock absorber described in claim 16, wherein the recess is a tapered hole.

19. The elevator shock absorber described in claim 18, wherein the pressing body has a conical trapezoidal shape that is configured to engage the tapered hole of the recess.

20. The elevator shock absorber described in claim 16, wherein the pressing body has a conical trapezoidal shape.

21. The elevator shock absorber described in claim 17, wherein the recess is a tapered hole.

22. The elevator shock absorber described in claim 21, wherein the pressing body has a conical trapezoidal shape that is configured to engage the tapered hole of the recess.

23. The elevator shock absorber described in claim 16, wherein the shock absorbing body has an outer surface that is reinforced with a frame.

24. The elevator shock absorber described in claim 17, wherein the shock absorbing body has an outer surface that is reinforced with a frame.

25. The elevator shock absorber described in claim 18, wherein the shock absorbing body has an outer surface that is reinforced with a frame.

26. The elevator shock absorber described in claim 20, wherein the shock absorbing body has an outer surface that is reinforced with a frame.

27. The elevator shock absorber described in the claim 16, wherein the shock absorbing body is formed of an elastically deformable material.

28. The elevator shock absorber described in claim 16, wherein the inclined surface of the shock absorbing body has a substantially V-shaped cross-section

29. The elevator shock absorber described in claim 16, wherein the inclined surface of the pressing body has a substantially V-shaped cross-section.

30. The elevator shock absorber described in claim 28, wherein the inclined surface of the pressing body has a substantially V-shaped cross-section.
